(19) United States
(12) Patent Application Publication
(10) Pub. No.: US 2004/0260616 A1
(43) Pub. Date: Dec. 23, 2004

(54) Color temperature-regulable led light

(76) Inventor: Markku Lemetyinen, Clifton Park, NY (US)

Correspondence Address: STIENNON & STIENNON, 612 W. MAIN ST., SUITE 201, P.O. BOX 1667, MADISON, WI, 53701-1667, US

(21) Appl. No.: 10/496,088

(22) PCT Filed: Nov. 15, 2002
(86) PCT No.: PCT/FI02/00906

Related U.S. Application Data
(60) Provisional application No. 60/332,626, filed on Nov. 23, 2001.

(30) Foreign Application Priority Data
Nov. 22, 2001 (FI) 20015040

(51) Int. Cl. G06F 17/60

(52) U.S. Cl. 705/26

(57) ABSTRACT

A delivery system for consumption and/or spare parts of machinery and equipment in the processing industries. In the system the supplier prepares the spare part as a blank, which is finished except for customer-specific characteristics. The customer contacts the supplier's portal and places an order for a spare part. The supplier registers the order and arranges for transportation of a spare part blank with a special vehicle, equipped to finish the spare part blank. The supplier finishes the spare part blank in the vehicle and delivers it to the customer.

### CROSS REFERENCES TO RELATED APPLICATIONS

This application is a U.S. National Stage application of PCT/F102/00906, filed Nov. 15, 2002, and claims priority on Finnish Application No. 20015040, Filed Nov. 22, 2001, and claims the benefit of priority of U.S. app. Ser. No. 60/332,626, filed Nov. 23, 2001.

### FEDERALLY SPONSORED RESEARCH AND DEVELOPMENT

Not applicable.

### BACKGROUND OF THE INVENTION

The invention concerns a delivery system for consumption and/or spare parts for machinery and equipment in the processing industries, wherein the parties are at least one customer using consumption and/or spare parts and at least one supplier of consumption and/or spare parts and wherein

need occurs at the customer's for purchasing at least one consumption and/or spare part,

the customer specifies his need for the consumption and/or spare part,

the customer sends to the supplier an order for the consumption and/or spare part he has specified,

the supplier prepares and delivers the said consumption and/or spare part to the customer, and

the customer receives the said consumption and/or spare part.

Examples of consumables used in machines of the processing industries are e. g. the blades used in doctor equipment, which are used to maintain the operating ability of paper or board machine rolls and which are thus located in an essentially important part in view of the machine's runnability. The doctor blades, of which there are usually between 50 and 60, depending on the machine concept, wear irregularly in the doctoring of rolls, thus causing an essentially poorer grip and in consequence an essentially poorer cleaning result.

Other examples of consumables relating to the processing industries branch are the coating rods used in coating equipment classified as finishing machines. With these rods, which may be grooved, the coating paste is spread out evenly e.g. on the roll surface, whence it is transferred further into the paper. The rod grooves will wear in use, whereby they must be replaced with new ones from time to time.

Examples of consumables in the stone crushing industry are e.g. the various meshes made of polyurethane and rubber. These must be replaced from time to time, not only due to wear and damage, but also when the screening result is to be changed.

Additional examples are the lubrication and cooling systems of machinery and equipment in the processing industries, as well as various analysers used by the industries, which contain filters that must be changed from time to time.

Only some examples were presented above of the numerous different consumption and spare parts of different types, which are needed in the processing industries. All things considered, their purchasing, inventorying and problems occurring in operation bind considerable resources of the factories and plants from their proper main business area and may even form bottlenecks in the production, if they do not function in the desired manner. On the other hand, even the processing industries aim at focusing on their customer relations and on their own central know-how, to which maintenance and service functions of equipment seldom belong. This has in fact made production plants reduce their staff from these functions and sometimes even entirely externalize their maintenance and service functions.

For example, in the case of doctor blades the customer, which hereinafter may mean e.g. a paper manufacturer, often finds the compulsory blade inventory to be a confused and difficult action. For example, storekeeping of blades may be arranged in a confused and decentralized manner in the factory area. Furthermore, there may be several different types of blade models, each one of which has a certain carefully defined position of its own, which is the only one where the blade in question fits e.g. as regards its model and manner of attachment. According to modern practice, blades are delivered to the factory in boxes, which the customer then stocks on his premises in order to prevent running out of blades.

Ordering of blades must be known in advance in good time before running out of blades, because according to the state of the art the way in which blades are made and delivered takes a week on an average, which is a relatively long time, for example, in an emergency situation unexpectedly occurring at the customer's. The ordering process with all specifications relating to blade details will take the customer's time and is troublesome.

If the situation is really an emergency from the customer's point of view, when the customer runs out of e.g. a blade model of a certain type for some of the above-mentioned reasons, then it is demanded that the machine must be stopped in the worst case and significant losses of production will often result due to unreasonably long delivery times of new blades. If required, the blade delivery may be speeded up as the customer's order bypasses the supplier's current order and production queue, but in this case the customer will then incur correspondingly higher costs.

Furthermore, the customer may arise an interest to test run in his own machine environment a new type of blade launched on the market. However, arranging a test run takes an unreasonably long time due, among other things, to the mentioned disadvantageously long delivery times of blades.

Due to the degree of finishing of doctor blades being advanced even at the manufacturing stage they are subject to cost pressures, which from the customer's point of view emerge as a high price of doctor blades. The availability of information relating to doctor blades is difficult, partly due to the distant relationship between their supplier and the customer. Blade information does not always necessarily exist, because of the customer's and supplier's mutual poor knowledge of one another and because the blade supplier is not necessarily even the customer's actual machine supplier. In such a situation, the blade supplier has no knowledge of the customer's precise machine concept and of any relating compatibility problems. Nor is the supplier aware of the habitual use of the customer's consumption and spare parts and e.g. of the average useful life of blades, which may indicate this subconscious problem at the customer's.

At the present time blades are made at traditional blade workshops including riveting machines as well as complete cutting and bevelling equipment along with blade packaging equipment. The blades are made (for example, cut according to the location position) into their final shape according to specifications given by the customer.

The solution presented in patent application FI-980514 is further referred to as the state of the art, which solution has special equipment for cutting off doctor blades into the desired blade length. In this equipment the customer must further take inventory e.g. of the consumption of blades, and based on this he must take steps to supplement his blade reserve.

Reference is also made to patent application FI-20002830 as the state of the art. It presents a method, wherein ready-made doctor blades are stocked at a paper factory and the number of used blades is monitored. Information on the number of doctor blades is relayed further to the blade supplier's data management system in such a way that the supplier is able to maintain the desired number of blades at the factory. It is a problem with this solution that the customer still has to keep in store quite a lot of various doctor blades in order to make sure that he will always have such doctor blades available, which will be suitable for every individual application. Naturally, this binds capital in unproductive storekeeping.

### SUMMARY OF THE INVENTION

It is a purpose of the present invention to bring about a system of a new kind avoiding the above-mentioned drawbacks and faults and which can be used to carry out steps relating to consumption and spare parts, such as their delivery and distribution of information and know-how concerning them, considerably faster, more efficiently and comprehensively than before.

It is a characteristic feature of the system according to the invention that the customer can attend easily and efficiently to steps relating to e.g. the purchasing of consumption and spare parts, to information acquisition and to problem solving through a special consumption and spare parts portal arranged in a data network from a single site, which provides a purposeful way of ordering the concerned parts, of arranging the related training, of problem-solving and virtual monitoring. Through the data network the supplier of consumption and spare parts is able in a much shorter time and with higher cost efficiency to provide know-how and also to deliver to the customer the consumption and spare parts he has ordered, which will benefit both the customer party and the supplier party.

The system according to the invention can be advantageously applied to such consumption and spare parts, which can be finished by simple acts from a ready-made blank at the customer's place into a product specified for the customer's machine concept. The selection of parts becomes simpler and is reduced essentially from the known selection. One such consumable is the doctor blade, because these can be prepared beforehand as blanks, from which object-specific blades can be made. This is made possible by the manner in which blades are attached, which can advantageously be formed to be almost independent of the blade holder.

According to an advantageous embodiment, the ready-made consumption and/or spare part blanks may be arranged in a special vehicle making possible the supplier to move freely e.g. from one customer to another and finishing of the parts at the customer's place at the place where they will be used. This allows an especially smooth delivery of consumption and spare parts compared with the state of the art. The doctor blade is again a good example of a consumable for the delivery of which the system according to the present invention can be advantageously utilized.

According to another advantageous embodiment, a special automaton can be arranged at the customer's place, which automaton is programmed to finish customer-specific parts from ready-made consumption or spare part blanks.

Essential in the system according to the invention is the connection of the customer's special consumption and spare parts vehicle and consumption and spare parts automaton by way of a data network with the supplier's data system, wherein e.g. the customer's orders and inquiries are registered, and information relating to the sales of consumption and/or spare parts is transferred through the data network and stored therein. With the said information the supplier can monitor the customer's process, make analyses concerning consumption and spare parts and use the information e.g. in simulations, with which new information can be formed advantageously and new solutions can be developed for the said consumption and spare parts.

The customer achieves several significant advantages with the system according to the invention. For example, in the case of doctor blades, blade costs are reduced and the need for inventorying is essentially reduced. In one application of the invention, the customer avoids all costs of keeping blades in stock and he pays for the blade only when putting it into use. Emergency deliveries become more accurate and the blade testing done at the factory becomes much easier than before.

To the supplier this invention offers advantages, among other things, essentially improved and easier communications with every customer, irrespective of the customer's size or the extent of his business operations. In addition to the simplified process for making consumption and spare parts, the system allows prompt reactions to the customer's demands and requests. As the final result, the system brings about significant advantages both for the customer and for the supplier. Other features characteristics of the invention emerge from the appended claims and from the specification part.

### BRIEF DESCRIPTION OF THE DRAWINGS

In the following, the invention will be described in greater detail with the aid of examples and with reference to the appended drawings.

FIG. 1 is a schematic view of the parties to the delivery system for consumption and spare parts according to the invention applied to the papermaking industry.

FIG. 2 shows an example of a blade clamp making possible the doctor blade delivery system according to the invention.

FIGS. 3a, 3b and 3c show use of the blade clamp of FIG. 2 in different blade holders.

FIG. 4 shows another example of a blade clamp making possible the doctor blade delivery system according to the invention.

FIGS. 5a, 5b and 5c show use of the blade clamp of FIG. 4 in different blade holders.

### DESCRIPTION OF THE PREFERRED EMBODIMENTS

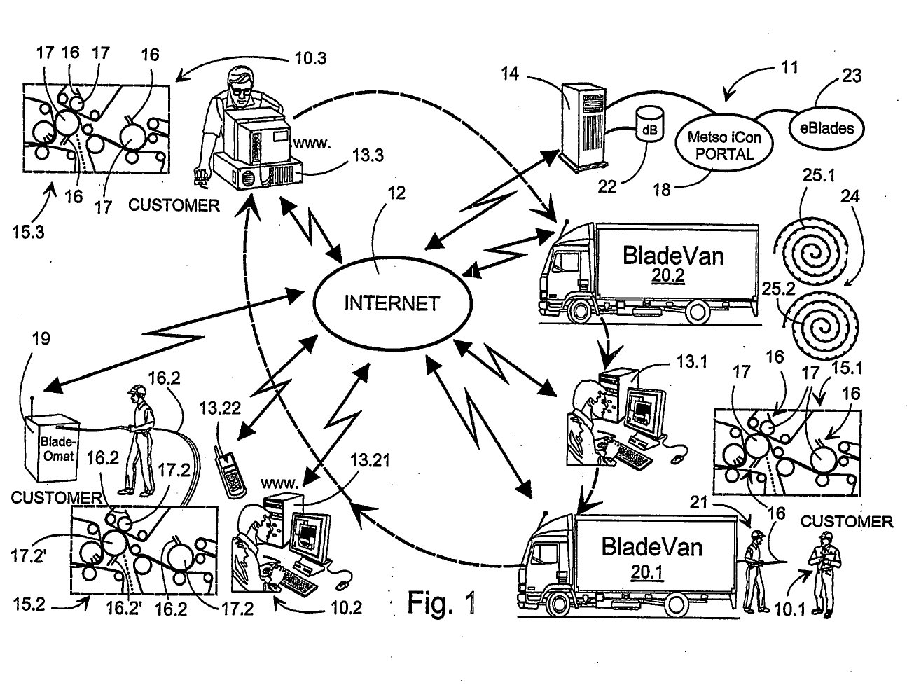

FIG. 1 is a schematic view of an application example embodying the delivery system for consumption and spare parts according to the invention. The figure shows the parties to the system, who are the customer 10.1, 10.2, 10.3, the supplier 11 of consumption and spare parts, and the construction of protected data communication connections for these by way of a data network 12.

The data network for use in data transmission may advantageously be, for example, an Internet network 12, wherein the setting up of connections between the terminal equipment 13.1, 13.21, 13.22, 13.3 of customers 10.1, 10.2, 10.3 and the supplier's 11 server machine 14 takes place according to technology known as such and this will not be described further in this context. The terminal equipment used may be e.g. a computer 13.1, 13.21, 13.3 or a mobile station 13.22, a hand-held computer or some other terminal equipment allowing direct (with the http protocol) or indirect (e.g. with a mobile station or the WAP protocol) communication in the said data network 12.

The said customer 10.1, 10.2, 10.3 may be, for example, a paper or board maker, a surface finisher or a pulp maker. The supplier 11 may be, for example, a supplier of paper, board, surface finishing or pulp machines or a manufacturer or possibly a distributor of consumption and spare parts for the machines in question.

As a possible advantageous form of application the system according to the invention may be used e.g. for the doctor blades 16, 16.2, which are to be presented in the following application example and which form a significant part of the consumables of e.g. a papermaking machine 15.1, 15.2, 15.3. FIG. 1 shows the press section of a papermaking machine 15.1, 15.2, 15.3, wherein the said doctor blades 16, 16.2 have a role significant to the runnability of the machine in the cleaning and servicing of rolls 17, 17.2, 17.2′. Besides the press section, many blades are used e.g. in the drying section. However, application of the system according to the invention is suitable not only with doctor blades 16, 16.2, but also with numerous other consumption and spare parts, such as, for example, for spreading rods of coating equipment, for meshes used in stone crushers etc.

The system according to the invention consists mainly of four different elements. An essential part is the Metso iCon consumption and spare parts portal 18, which is operated through the Internet network 12 and maintained by a server machine 14. The portal complex 18 includes as sub-modules, for example, a service entity applet (eBlades) 23 providing a pleasant, easy and economic way of purchasing blades 16, 16.2. The entity further includes an automatic dispenser (BladeOmat) 19 of doctor blades 16.2 which can be located e.g. near the papermaking machine 15.2. The fourth element is a special blade vehicle (BladeVan) 20.1, 20.2, which is e.g. a mobile blade-finishing workshop driven by a blade specialist 21.

In the delivery system according to the invention, the special Metso iCon www portal 18 has an essential part which is available through data network 12, to which the customer 10.1, 10.2, 10.3 may transfer with his terminal equipment 13.1, 13.21, 13.22, 13.3 to find out solutions to his own doctor blade requirements. The said www portal 18 is located e.g. on a server machine 14 administered and/or maintained by the doctor blade supplier 11. For example, a customer and order database dB 22 and extensive document libraries in electronic format, for example, of product, reference and other information readable by the customers 10.1, 10.2, 10.3 are also arranged on the server machine 14.

The Metso eBlades applet tool 23 arranged at portal 18 provides doctor blade customers 10.1, 10.2, 10.3 with all-inclusive service, for example, for ordering blades 16,16.2 in a pleasant and cost efficient manner. The eBlades tool 23 guides the customer 10.3 according to his choice, for example, in the acquisition of a new blade 16.

The eBlades tool 23 includes a sales configurator guiding the customer 10.1, 10.2, 10.3 through the purchasing process to a final result, which is successful and instructive from the customer's point of view. The blade delivery can be chosen to take place, for example, with the said BladeVan 20.1, 20.2 or from BladeOmat 19, which the customer 10.1, 10.2, 10.3 can order to his papermaking machine 15.1, 15.2, 15.4 through the said www portal 18.

The eBlades tool 23 is also designed to help the customer in problematic situations relating to blades, and a virtual blade specialist (not shown) is arranged together with it as a problem-solving applet, which will solve doctoring problems occurring at the customer's 10.1. The customer 10.1 answers the questions made by the blade specialist, and from these answers the specialist automatically forms a preliminary problem-solving proposal, based on which the customer 10.1 and the supplier 11 may begin solving the problem. If required, the sales configurator may be supported by interactive software based on fuzzy deduction, which makes it easier to identify qualitative customer expectations and to find the optimum solution to these.

In the training applet of the eBlades tool 23, the customer may also control a virtual doctor, which may be used to simulate different doctoring situations and doctor models easily and realistically.

Furthermore, a reference library arranged in connection with the eBlades tool 23 helps in selecting the blade material best suited for the application, and newsletters present new products recently arrived in the market etc. Through the portal 18 it is also possible to order the doctor blade specialist 21, doctor service or a test run of new blades etc. for the papermaking machine 15.1, 15.2, 15.3. The portal 18 is designed to be pleasant and easy to use and its use is made very instructive.

For the technical implementation of the portal 18 and submodules 23 linked to it there are numerous known ways, and their implementation will not be described in greater detail herein.

According to the system of the invention, the doctor blades 16 are made in their manufacturing step at supplier's 11 blade workshop 24 as ready-made blanks 25.1, 25.2 only lacking their customer-specific characteristics, and the blanks can be advantageously finished with minor and simple steps into a blade 16, 16.2 for each customer 10.1, 10.2, 10.3 specified according to his machine concept 15.1, 15.2, 15.3.

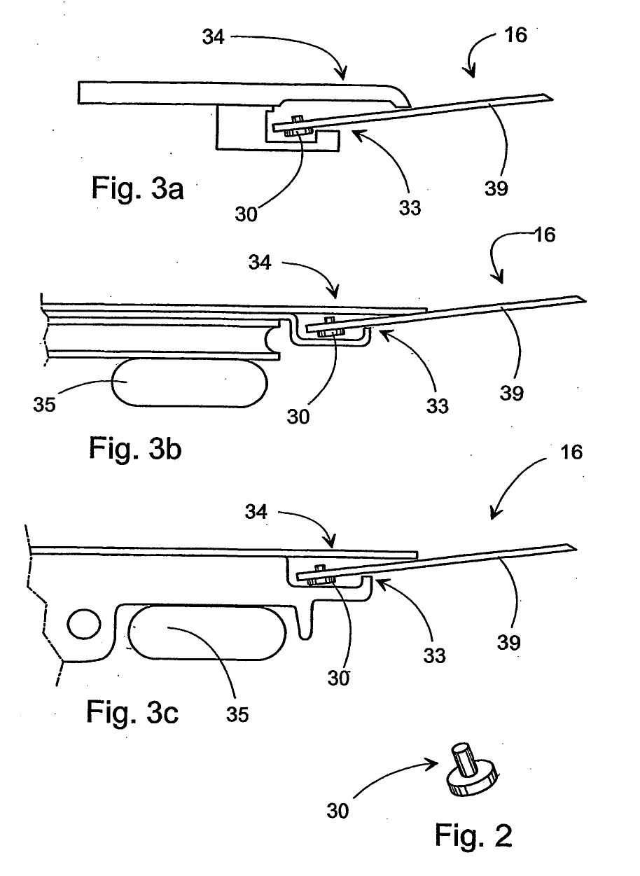

The steps of blade 16, 16.2 manufacture consist, for example, of bevelling of the blade 16, 16.2 tip and of cutting off of the blade strip into lengths of a certain size, for example, 150 meters. The application form is made possible by a new type of blade 16, 16.2 clamp arrangement, wherein the blade strips are perforated e.g. at equal intervals at a distance of 36 inches from each other from the side opposite to their bevel side, and special clamps independent of the blade holder are placed in them, which clamps are almost as a universal solution independent of the model of blade holder being used. Examples of the said universal clamps will be presented later in the specification referring to FIGS. 2-5a, b, c.

Next, the operation of the system according to the invention will be described in the case of the said doctor blades 16, 16.2 and relying on FIG. 1. As they are consumption and spare parts, the doctor blades 16, 16.2 must be replaced with new ones from time to time and at more or less regular intervals. Problems demanding e.g. service steps may also occur in them and often the customer 10.1, 10.2, 10.3 lacks resources for solving the problems. Hereby the customer 10.1, 10.2, 10.3 places a blade order or notifies the supplier 11 of the problems relating to blades to the Metso iCon www portal 18 run by the server machine 14.

The supplier 11 registers on his server machine 14 the customer's 10.1, 10.2, 10.3 order and what he has reported. The blade and/or specialist order is entered in the database dB 22 maintained at the server machine 14 and it is relayed further immediately, for example, to the blade workshop 24 or to the dispatching department or to the blade specialist 21, and here the steps required by the order will be taken forthwith.

At the blade workshop 24 the blade blanks 25.1,25.2 may be made with a very high degree of completion and packed e.g. in coils. This for its part makes possible a quick and efficient reaction to execute the customer's 10.1, 10.2, 10.3 order.

In an embodiment of the invention, the doctor blade 16 supplier 11 has one or more special vehicles (BladeVan) 20.1, 20.2, which may be run, for example, by the said blade specialist 21. The ready-made and pre-riveted blade blanks 25.1, 25.2 are arranged in the BladeVan 20.1, 20.2 e.g. at the blade blank workshop 24. In the case shown in the application example, BladeVan 20.1, 20.2 is equipped with means (not shown) for finishing the doctor blades 16, which include e.g. a set of means needed for mounting the said blade clamps together with equipment for cutting off the blade 16 to a certain size. Thus, the blade specialist 21 may drive the BladeVan 20.1, 20.2 to the place where the blades 16 are used, which allows an especially smooth delivery of blades 16 compared with the known technique (the route is indicated by a dashed arrow line). The most advantageous operating radius of the BladeVan 20.1, 20.2 is 400 km, which makes possible a delivery of blades within approximately 5 hours. Besides the blade delivery, the customer 10.1, 10.2, 10.3 at the same time gets from the BladeVan 20.1, 20.2 full services of the blade specialist 21 in possible problematic situations and also the possibility of a smooth test run, should he so desire.

The location of BladeVan 20.1, 20.2 can be followed with the aid of a GPS signal. This makes it possible to optimize the route of the vehicle 20.1, 20.2 according to the current need of customer situation and to give to the customer 10.1, 10.2, 10.3 also an accurate prognosis of when the blade specialist 21 will be at the factory with his vehicle 20.1, 20.2. The GPS can also be utilized to guide the specialist 21 to the factory along the route taking the shortest time.

Finishing of the blades 16 from the BladeVan 20.1, 20.2 is arranged to take place in such a way that each customer 10.1, 10.2, 10.3 has his own order number, which is entered into the finishing equipment of BladeVan 20.1, 20.2, which finishing equipment may preferably be of a corresponding kind as the automatic blade dispenser 19, which will be presented hereinafter. Information emerging from the order number is such as the customer's 10.1 production plant, machine 15.1 and the position, for which the finishing equipment makes a suitable blade 16. The order number is preferably in bar code form, whereby it is easily read by a bar code reader.

According to another advantageous embodiment of the invention, the supplier 11 of blades 16.2 may arrange a special blade automaton (BladeOmat) 19 for the customer 10.2, which automaton functions as a special automatic vending machine for blades 16.2, 16.2′. The customer 10.2 can perform supplementing of the BladeOmat's 19 blade reserve e.g. by using a mobile station terminal 13.22 or through the Internet 12 by way of the Metso iCon www portal 18. In his order the customer 10.2 states, for example, the blade type and length he needs, which is determined by the customer's 10.2 machine concept 15.2. According to the specified blade length, supplier 11 makes a pre-riveted blade blank, which he delivers to the place where the blades 16.2, 16.2′ are used as supplement to the BladeOmat 19, for example, the doctor blade specialist 21 maintaining the local BladeOmat 19 from the stock of pre-riveted blades in his BladeVan 20.1 or in some other suitable mode of transportation.

In a third advantageous form of application, data communication connections are arranged in the BladeOmat 19 to relay information to the supplier 11 on the customer's 10.2 blade events by way of the data network 12. BladeOmat 19 may send a possible request for supplementing of the blade reserve to supplier 11 through the data network 12 directly, so that the customer 10.2 need not attend to this separately.

BladeOmat 19 can be programmed on a customer-specific basis, whereby information relating to the customer's machine concept 15.2 can be placed therein, such as the widths and doctor positions of the rolls 17.2, 17.2′ be doctored, whereby it makes possible in a similar manner as the BladeVan finishing of the blade 16.2, 16.2′ a ready-made blank according to the customer-specific characteristics. BladeOmat 19 may also be connected through the data network 12 with supplier's 11 database dB 22, which contains the latest knowledge of doctors and of their suitability for different applications. BladeOmat 19 may hereby choose the blade blank best suited for the chosen application from those placed in its stock, for example, blanks made of a few different material compositions. It is sufficient for the customer 10.2 to specify only the papermaking machine 15.2 and the desired doctor position in the machine concerned, and the automaton 19 will take care of the rest.

BladeOmat 19 uncoils and cuts off the requested pre-riveted blade 16.2, while the customer 10.2 need only add possible end rivets to the blade 16.2, whereupon the blade 16.2 is ready for putting into use. BladeOmat 19 can preferably be used together with a so-called BladeFeed system, which is used to feed the blade automatically into its holder (the applicant's patent application FI-20015006).

Naturally, BladeOmat 19 may also be equipped with blades 16.2, 16.2′ made ready for different positions of the papermaking machine 15.2, so that it need not itself do any necessary finishing work. However, all advantages of the invention are not then realized to their full extent. For example, the supplier 11 must keep quite a large stock of doctor blades in order to make sure that he will be able to provide all BladeOmat automatons 19 with the different blades needed by the customers.

The customer 10.1, 10.2, 10.3, the BladeOmat 19 blade automaton and the BladeVan blade vehicle 20.1, 20.2 are preferably in connection through a data network 12 with a data system arranged at the supplier's 11 server machine 14 and with control of the manufacture of blade blanks 25.1, 25.2. E.g. information relating to the consumption of blades 16, 16.2 is registered in the data system and this information is utilized, for example, in correlation analyses, where it is possible e.g. to study the blade consumption of each individual machine as well as the effect of different run or concept parameters on the blade's 16,16.2 behavior. The gathered information may also be used in simulations, which can advantageously be used for enlarging the blade information and for developing new and constantly better blade solutions.

The excessive smoothness of the middle roll 17.2′ the press section of a customer's 10.2 papermaking machine 15.2 emerging as reduced wear of the blade 16.2′ shown as an example of problems which can be found when observing blade consumption. If blade 16.2′ wears too quickly, then runnability problems may occur. Thus, the method according to the invention allows good alarms and analyses both in the case of blade 16.2′ wear and also in the case of non-wear.

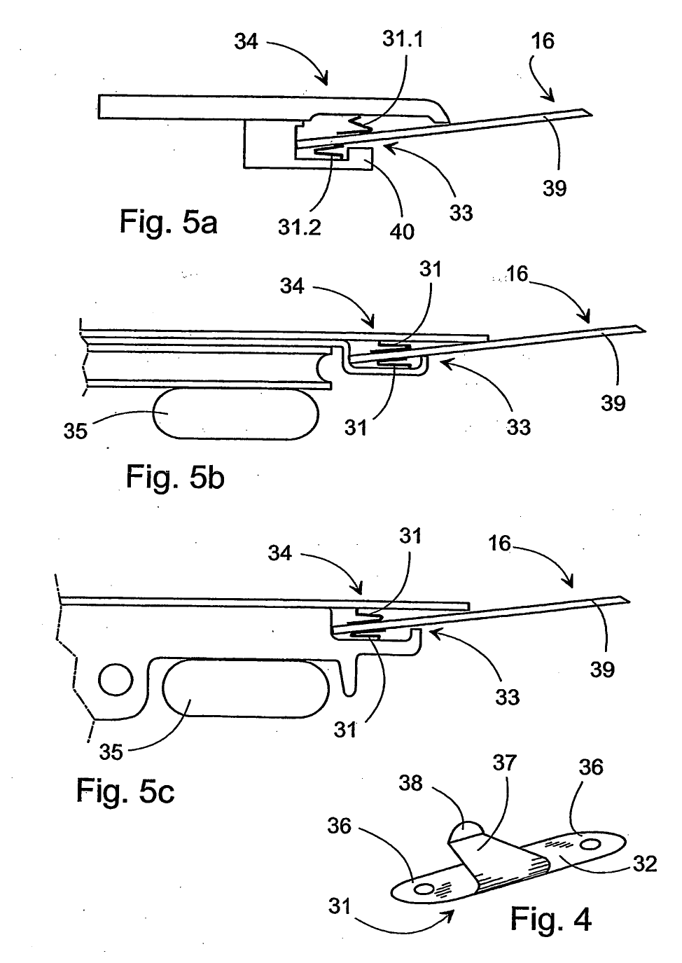

FIGS. 2 and 4 show the entirely new kind of clamp 30, 31 for the doctor blade 16, 16.2, 16.2′ making possible the system according to the invention and the operation of e.g. BladeVan 20.1, 20.2 and BladeOmat 19. This universal clamp 30, 31 may according to an advantageous embodiment be the simple rivet 30 shown in FIG. 2, which reduces the number of necessary blade types to three. Of these two may cover 98% of the doctors in use. Rivet 30 allows universal compatibility with almost all doctor blade holders 34 in use. FIGS. 3a, 3b and 3c show examples of the said blade holders 34 in the case of rivet 30.

FIG. 3a shows a fixed type of blade holder 34 and FIGS. 3b and 3c show blade holders 34 loaded by a hose 35. In these a rivet 30 arranged in the blade part 39 is placed in groove 33 in the blade holder 34, and when blade part 39 is loaded against the rotating roll it cannot slip out of the groove, because the rivet 30 fit is made accurate as regards both its place and height.

Instead of the rivet 30 shown in FIG. 2, a flexible means, clips 31, of the kind attached on opposite sides of the blade part 39, may be used as another advantageous universal blade 16, 16.2 clamp.

Clip 31 is formed e.g. by a metal strip 32, to which a flexible tongue 37 is bent, and further by a barb 38 bent to the end of tongue 37. There are holes 36 in the metal strip 32 for its attachment, for example, with rivets (not shown) to the blade part 39.

In the case of clips 31 two holes are drilled into the blade part 39, from which holes clips 31 placed on opposite sides of blade part 39 are attached by rivets (not shown). In the case of the fixed blade holder 34 shown in FIG. 5a, clips 31.1, 31.2 are not matching exactly, but e.g. the clip 31.1 located above the blade part 39 is located essentially at the threshold 40 of blade holder 34 and the clip 31.2 located below is located in the groove 33 of the blade holder. In the blade holders 34 shown in FIGS. 5band 5c, both clips 31 are attached essentially in the same holes of the blade part 39, but their tongues 37 are pointing in different directions in such a way that the tongue 37 of the clip 31 located under blade part 39 points in the direction of the bevelled side of blade part 34 and the tongue 37 of clip 31 located above points in the direction of the side opposite to the bevelled side of blade part 39.

In the system according to the invention, an invoicing system is preferably linked to a consumption and/or spare parts automaton or vehicle, such as the BladeOmat 19 and BladeVan 20.1, 20.2 according to the doctor blade example described above. The consumption and/or spare parts automaton may preferably be arranged with the customer 10.2 under a leasing agreement, whereby the customer will only pay for the consumption and/or spare parts he uses.

The delivery system according to the invention is suitable not only for the application example presented above, which describes delivery of doctor blades, but also for e.g. delivery of coating rods of coating equipment classified as finishing machines and of consumables of the rock crushing industry, such as various meshes made of polyurethane and rubber.

Still other examples of consumption and spare parts, which can be advantageously delivered to the customer by utilizing the system according to the invention, are lubrication and cooling systems of machines and equipment in the processing industries, as well as various analyzers used by the industries and containing filters that must be replaced from time to time, and generally spare components necessary in the control and adjustment of machines and equipment and the whole process in the processing industries. Such are, for example, replaceable cards, which can replace a failed circuit either as such or configured.

More and more often the supplier sells reliable operation to his customer instead of the traditional consumption and spare parts. Thus, the price obtained by the supplier is not determined by how many such parts he delivers, but by how well the supplier is able to keep the customer's machine or process in operation. Thus, in the doctor blade case described as an example the supplier no longer necessarily sells separate blades, but what he sells is doctoring ability under an agreement. The agreement may also include training provided by the supplier as well as consultancy in problematic situations, for example, by utilizing a portal developed for this purpose. The present invention provides the supplier with a new advantageous way of implementing this new operational model. The supplier can in a cost efficient way make sure that the correct consumption or spare part is always available to the customer and that the customer can also have a specialist visit his premises promptly when required. The supplier collects information on the sales of consumption and spare parts under different circumstances. This information he may use later both in developing new machine solutions and in pricing the service he offers.

It should be understood that the above description and the figures relating to it are intended only to illustrate the present invention. Thus, the invention is not limited only to the embodiments presented above or defined in the claims, but many such different variations, modifications and applications will be obvious to the professional in the field, which are possible within the scope of the inventive idea defined in the appended claims.

1-22. (cancelled).

23. A method of supplying doctor blades for a paper or a board machine, from a supplier of doctor blades to a customer of doctor blades, comprising the steps of:
preparing a doctor blade blank, which is finished except for customer-specific characteristics, before receiving an order for a selected doctor blade from the customer;
upon a need for the selected doctor blade arising at a customer plant, the customer placing an order for the selected doctor blade through a terminal connected to a data network to a server administered and/or maintained by the supplier of doctor blades, the doctor blade being ordered in accordance with a specification provided by the customer which provides the customer-specific characteristics needed to complete the doctor blade;
transporting to the customer plant, a vehicle containing doctor finishing equipment, and the doctor blank;
finishing the doctor blank to the customer-specific characteristics on the finishing equipment in the vehicle; and
delivering the doctor blade to the customer.

24. The method of supplying doctor blades of claim 24 wherein the vehicle sends doctor blade information over a data communication link through the data network to a data system administered and/or maintained by the supplier of doctor blades, and wherein said data is used to perform a function selected from the group of functions consisting of: arranging an invoice, performing a simulation, and developing equipment concepts.

25. The method of supplying doctor blades of claim 24 wherein the supplier makes a proposal to the customer through the said data network for alternative doctor blades based on the received doctor blade information and for development of closely related process applications.

26. The method of supplying doctor blades of claim 23 wherein the vehicle is equipped with positioning means in order to determine the vehicle's location at selected times.

27. The method of supplying doctor blades of claim 23 wherein in the vehicle a place is arranged for a doctor blades specialist.

28. The method of supplying doctor blades of claim 23 wherein a portal is arranged at the said server machine and the portal includes as sub-modules at least one applet from the group comprising an applet for ordering doctor blades, an applet for virtual instruction and problem-solving, and an applet for a document library.

29. The method of supplying doctor blades of claim 23 further comprising in the step of making the doctor blade blank, the step of forming perforations in the blade blank, and attaching clamping means fitted to said perforations to attach the doctor blade in a doctor blade holder in the doctor blade's place of application.

30. The method of supplying doctor blades of claim 29 wherein the attaching clamping means is a rivet adapted to be used with a plurality of blade holder models.

31. The method of supplying doctor blades of claim 29 wherein the attaching clamping means is a metal strip having a bent flexible tongue, and further having a barb bent from an end of the tongue, the metal strip having holes for attachment.

32. The method of supplying doctor blades of claim 23 wherein the blade blank is packaged in a coil.

33. A method of supplying doctor blades for a paper or a board machine, from a supplier of doctor blades to a customer of doctor blades, comprising the steps of:
arranging a piece of equipment for finishing doctor blades at a customer's plant;
preparing a doctor blade blank, which is finished except for customer-specific characteristics, before receiving an order for a selected doctor blade from the customer;
receiving an order placed by a customer placing an order for the selected doctor blade through a terminal connected to a data network to a server administered and/or maintained by the supplier of doctor blades on which is located a portal for ordering doctor blades, the doctor blade being ordered in accordance with a specification provided by the customer which provides the customer-specific characteristics needed to complete the doctor blade;
transporting the doctor blank to the customer's plant;
finishing the doctor blank to the customer-specific characteristics on the finishing equipment at the customer's plant;
delivering the doctor blade to the customer; and
putting the doctor blade into operation.

34. The method of supplying doctor blades of claim 33 wherein the said piece of equipment is arranged to send doctor blade information over a data communication link through the said data network to a data system database maintained by the supplier and wherein said data is used to perform a function selected from the group of functions consisting of: arranging an invoicing, performing a simulation, and developing equipment concepts.

35. The method of supplying doctor blades of claim 33 wherein the portal includes as a sub-module an applet for ordering doctor blades and a virtual instruction and problem-solving applet and a document library.

36. The method of supplying doctor blades of claim 34 further comprising the step of make proposals to the customer through the data network for alternative doctor blades based on the received doctor blade information.

37. The method of supplying doctor blades of claim 33 wherein the piece of equipment for finishing doctor blades is programmed to choose the required doctor blade based on information given to it.

38. The method of supplying doctor blades of claim 33 wherein the step of making the doctor blade blank further comprises the steps of forming perforations in the blade blank, and attaching clamping means fitted to said perforations to attach the doctor blade in the a doctor blade holder in the doctor blade's place of application.

39. The method of supplying doctor blades of claim 38 wherein the attached clamping means is a rivet adapted to be used with a plurality of blade holder models.

40. The method of supplying doctor blades of claim 33 wherein the attached clamping means is a metal strip with a bent flexible tongue, and further having a barb bent from an end of the tongue, and wherein the metal strip has holes for attachment.

41. The method of supplying doctor blades of claim 33 wherein the blade blank is packaged in a coil.

42. A method of supplying doctor blades for a paper or board machine, from a supplier of doctor blades to a customer of doctor blades, comprising the steps of:
upon a need for a selected doctor arising at a customer plant, the customer placing an order for the selected doctor blade through a terminal connected to a data network to a server administered and/or maintained by the supplier of doctor blades on which is located a portal for ordering doctor blades, the doctor blade being ordered in accordance with a specification provided by the customer which provides the customer-specific characteristics needed to complete the doctor blade;
preparing a doctor blade, which is finished to customer-specific characteristics;
transporting the doctor blade to the customer plant and stocking the blade in a piece of equipment, the piece of equipment registering when a doctor blade is put in to use, wherein the piece of equipment is connected to the data network for sending doctor blade information over a data communication link to the supplier's data system;
the customer putting in to use said selected doctor to use it; and
the piece of equipment registering that the selected doctor blade is being put into use by the customer; and
the piece of equipment sending doctor blade information over a data communication link to a data system administered and/or maintained by the supplier of doctor blades.
